(19) United States
(12) Patent Application Publication
(10) Pub. No.: US 2026/0321868 A1
(43) Pub. Date: Oct. 15, 2026

(54) RECTANGULAR OR OBROUND PRESSURE RELIEF DEVICE

(71) Applicant: BS&B INNOVATIONS LIMITED, Limerick (IE)

(72) Inventors: Geoffrey BRAZIER, Woodbury, MN (US); Patrick Joseph Darcy, Shannon (IE); Gerard Joseph Horan, Limerick (IE)

(73) Assignee: BS&B INNOVATIONS LIMITED, Limerick (IE)

(21) Appl. No.: 19/465,867

(22) Filed: Jan. 30, 2026

Related U.S. Application Data
(60) Provisional application No. 63/752,317, filed on Jan. 31, 2025.

(51) Int. Cl. H01M 50/342

(52) U.S. Cl. CPC H01M 50/3425

(57) ABSTRACT

A pressure relief device is disclosed, such as may be used with a battery. According to one embodiment, the pressure relief device may comprise a flanged portion; a curved surface; and a line of weakness on the curved surface. The line of weakness may comprise a first end, a central line portion, and a second end, wherein at least one of the first end or the second end extends outside of a plane defined by the central line portion. The curved surface may have an aspect ratio greater than 1:1.

### CROSS-REFERENCE TO RELATED APPLICATIONS

The present application claims priority to and the benefits of U.S. Provisional Patent Application No. 63/752,317, filed on Jan. 31, 2025, the entire contents of which are incorporated herein by reference for all purposes.

### FIELD

This disclosure is directed to the field of pressure relief devices. Certain aspects of the present disclosure generally relate to improvements in non-reclosable pressure-relief devices, including improvements to such devices'ability to withstand pressure cycling, open at an accurate activation pressure, and/or provide sufficient ventilation.

### BACKGROUND

Battery devices may include several battery cells arranged in a battery pack configuration. Battery packs may comprise one or more individual battery cells that are electrically connected to achieve a desired voltage and power level. These battery cells may be sealed and/or otherwise packaged in containers ranging from flexible plastic pouches to metal enclosures. For example, the battery cells may be sealed to prevent ingress of dirt, dust, or moisture which might otherwise damage the cells or to simply provide for their mechanical protection. Sealing can also be used to facilitate cooling solutions (using a fluid such as air, liquid or gas) to help maintain the cells at an optimum temperature. As a result of this sealing, battery packs can undergo pressurization events (both positive and negative) caused by ambient temperature and pressure changes, temperature changes created by cooling systems (when present), but also in the case of a battery pack failure (e.g., cell malfunction).

For example, in a battery pack failure, the function of an individual cell or group of cells may be compromised because of cell degradation due to wear and tear, manufacturing defects, abnormal discharging conditions, as a result of an external impact, or as a consequence of being present in a fire or other unintended external event. In such cases, the electrodes or other components of the battery cell may undesirably contact each other mechanically or through the presence of an unintended conducting path and short circuit which produces significant energy discharge which triggers the release of heat energy. In some scenarios, through a process known as thermal runaway, the heat generated may overcome the battery pack's heat dissipation capacity and become self-sustaining, leading to the generation of further heat and pressure. This heat and pressure can vaporize and ignite the electrolyte resulting in an explosion and fire. A failure in a single cell can quickly increase temperatures in adjacent cells which in turn leads to the cascading failure of the entire battery pack. Therefore, a battery pack and/or individual battery cells may be provided with a pressure relief mechanism, which is designed to relieve internal pressure and avoid a destructive battery explosion.

Conventional pressure relief mechanisms comprise pressure relief devices and thermal cutout components intended to stop electrical conduction in a cell under adverse operating conditions. Conventional pressure relief devices range from very simplistic flat rupturable membranes affixed to the cell structure to fully fledged rupture disks that are specifically tailored to the application conditions (activation pressure, operating temperature, pressure cycling, etc.).

One conventional pressure relief mechanism, the simple flat rupturable membrane, may deform under internal or external working pressures (e.g., pressures created by cooling systems and/or ambient temperature changes) and such deformation may impact the pressure at which the device opens. Further, even when constructed of thicker material and with lines of weakness (e.g., in a preferred pattern of opening), these devices are not able to withstand pressure cycling (or other stresses, such as vibration) and often experience fatigue, leading to premature activation (e.g., opening at pressures lower than a set pressure of failure event).

As an alternative to the simple flat rupturable membrane, rupture disk technology has been developed and such devices are better able to withstand working pressure and pressure cycling to maintain an accurate activation pressure (e.g., open at a set pressure of failure event). However, these devices are often circular in shape and/or otherwise designed to take up a small amount of space. Therefore, these devices may not provide sufficient flow area once activated, and pressure relief may be hindered.

In view of the foregoing, the inventors recognized a need for an improved pressure relief device that can withstand working pressure, vibration, and pressure cycling while maintaining an accurate activation pressure and providing sufficient flow area.

### SUMMARY

To attain one or more of the above or other advantages, as embodied and broadly described herein, the disclosure is directed to a pressure relief device comprising a flanged portion, a curved surface, and one or more lines of weakness on the curved surface. The one or more lines of weakness may comprise a first end, a central line portion, and a second end, and at least one of the first end or the second end may extend outside of a plane defined by the central line portion. The curved surface may have an aspect ratio greater than 1:1.

The disclosure if further directed to a pressure relief device, comprising a flanged portion; a curved surface; a first line of weakness located along an apex of the curved surface, comprising a first end and a first central line portion; and a second line of weakness located along the apex of the curved surface, comprising a second end and a second central line portion. The first line of weakness and the second line of weakness may be symmetric about a longitudinal axis of the curved surface and may be discontinuous. The curved surface may have an aspect ratio greater than 1:1.

In another aspect, the disclosure is also directed to a pressure relief device comprising a flanged portion, a curved surface, and stitched score lines of weakness on the curved surface. The stitched score lines of weakness may comprise a first end, a central line portion, and a second end, and at least one of the first end or the second end may extends outside of a plane defined by the central line portion. The curved surface may have an aspect ratio greater than 1:1.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 illustrates an example pressure relief scenario, consistent with disclosed embodiments.

FIGS. 2A-2E illustrate example pressure relief devices, consistent with disclosed embodiments;

FIG. 3 illustrates another example pressure relief device, consistent with disclosed embodiments;

FIGS. 4A-4C illustrate example mounting of a pressure relief device, consistent with disclosed embodiments;

FIG. 5 illustrates example dimensions of a pressure relief device, consistent with disclosed embodiments.

### DESCRIPTION OF THE EMBODIMENTS

Reference will now be made in detail to the present exemplary embodiments, examples of which are illustrated in the accompanying drawings.

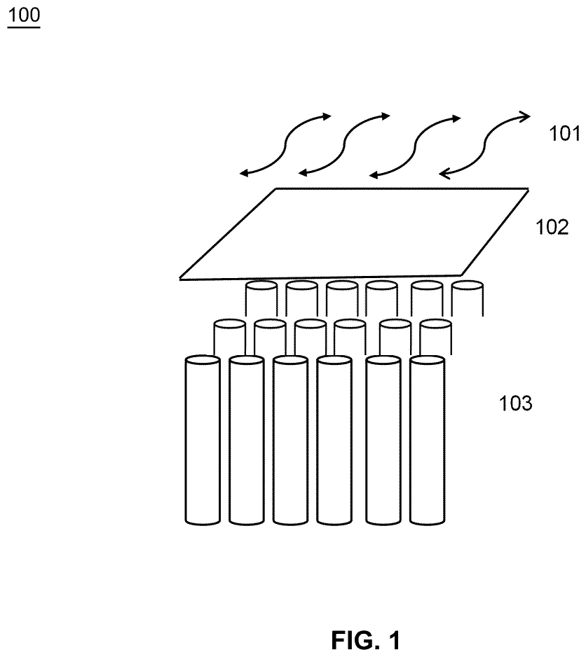

FIG. 1 illustrates an example of a pressure relief scenario, consistent with disclosed embodiments. As described above, a battery device 100 may comprise a plurality of battery cells 103 and an enclosure 102 (e.g., a container, seal, pouches, and/or other separation material). Further, battery device 100 may include thermal variation 101 on the inside and/or outside of the enclosure 102. A thermal variation may include a difference in temperature between two components and/or locations. For example, in some embodiments, thermal variation 101 may include temperature variation due to cooling components (e.g., liquid cooling and/or forced air cooling) on the outside of the enclosure 102. Enclosure 102 may include one or more pressure relief devices (not shown) designed to maintain the integrity of the enclosure under working pressure and pressure cycling (e.g., due to thermal variation 101 and/or heat generation of battery cells 103). The one or more pressure relief devices may further be designed to open at a set activation pressure and provide sufficient ventilation to avoid an explosion, overpressure, and/or under-pressure of battery device 100.

While FIG. 1 shows one example of a scenario where pressure relief is required, the disclosed pressure relief devices may be installed in a variety of different applications. For example, the disclosed pressure relief devices may be installed in air bag inflation systems used as automotive and other transportation safety devices, emergency breathing systems used in transportation applications and by fire departments, electrical enclosures used to protect instrumentation, energy switching systems such as may be used for power transmission and distribution, gas cabinets used for industrial gas handling, and/or in energy storage devices that accumulate and/or release fluid power such as compressed gases and liquids (e.g., uniquely shaped pressure vessels). In some embodiments, the disclosed pressure relief devices may be installed in applications with an explosive release (e.g., as described above with battery failure), while in other embodiments the devices may be installed in applications where pressure slowly rises until it reaches an activation pressure.

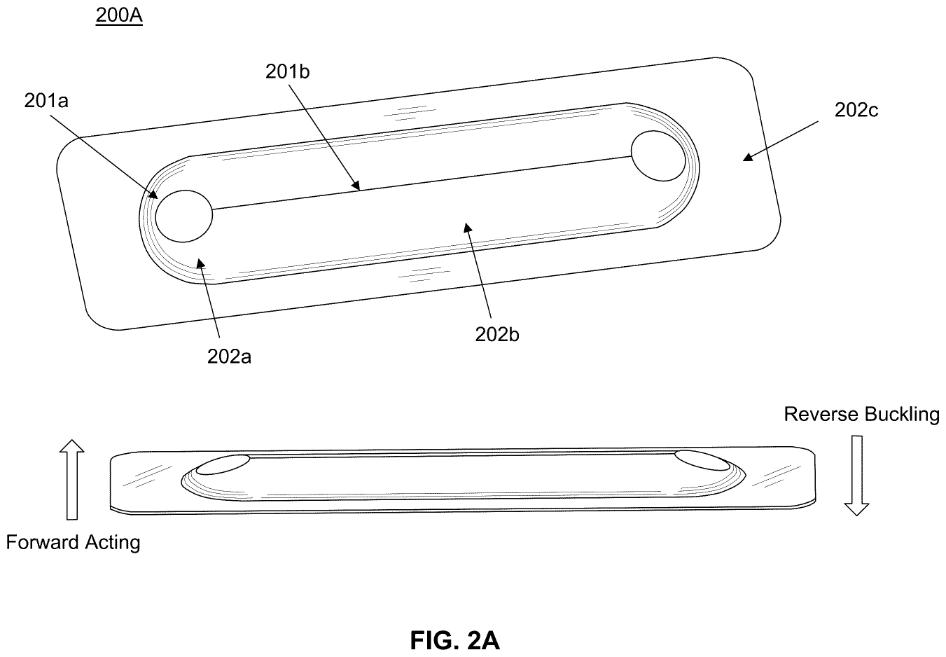

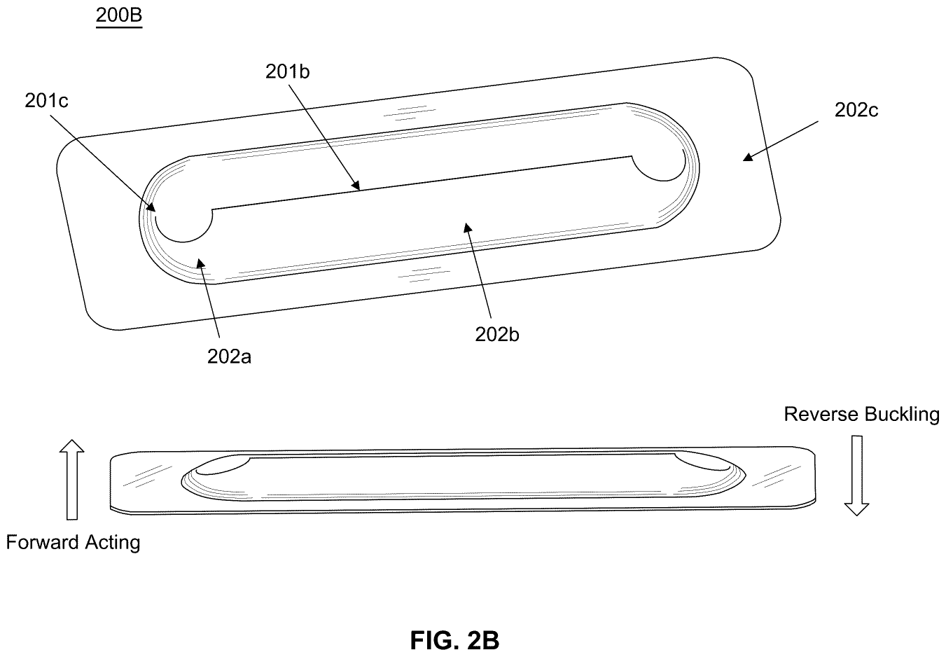

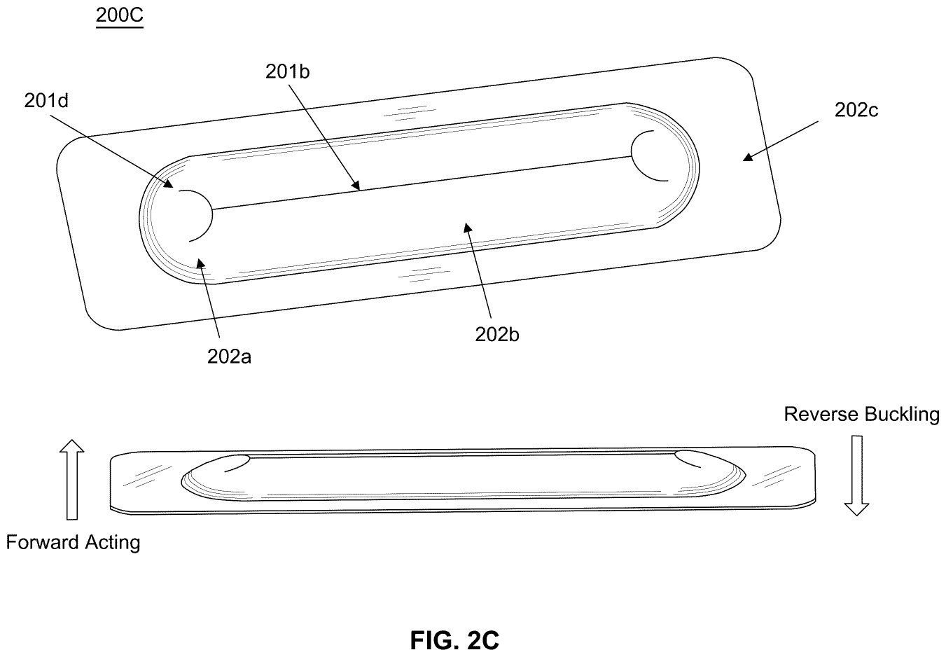

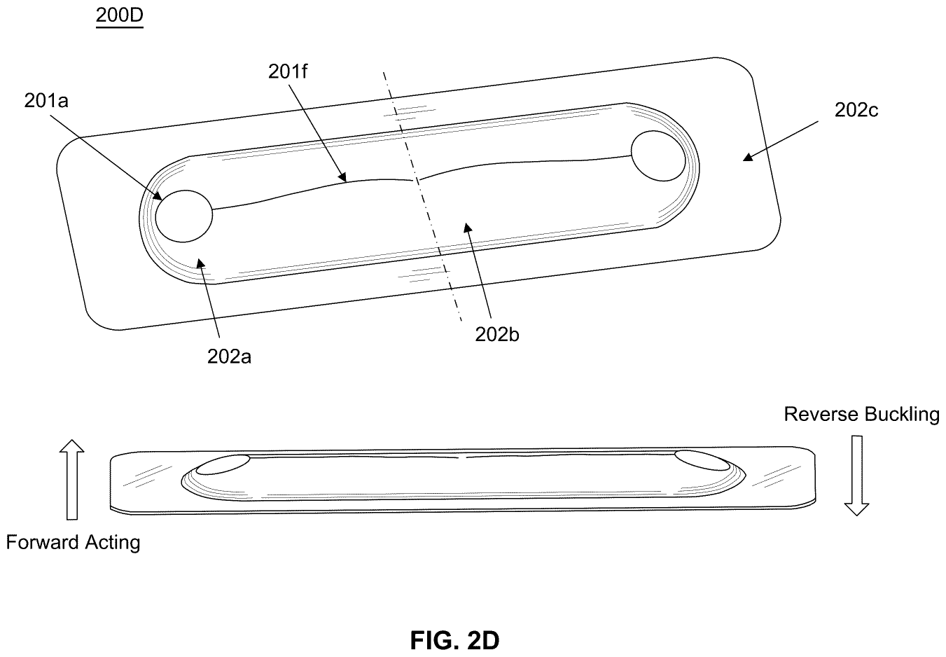

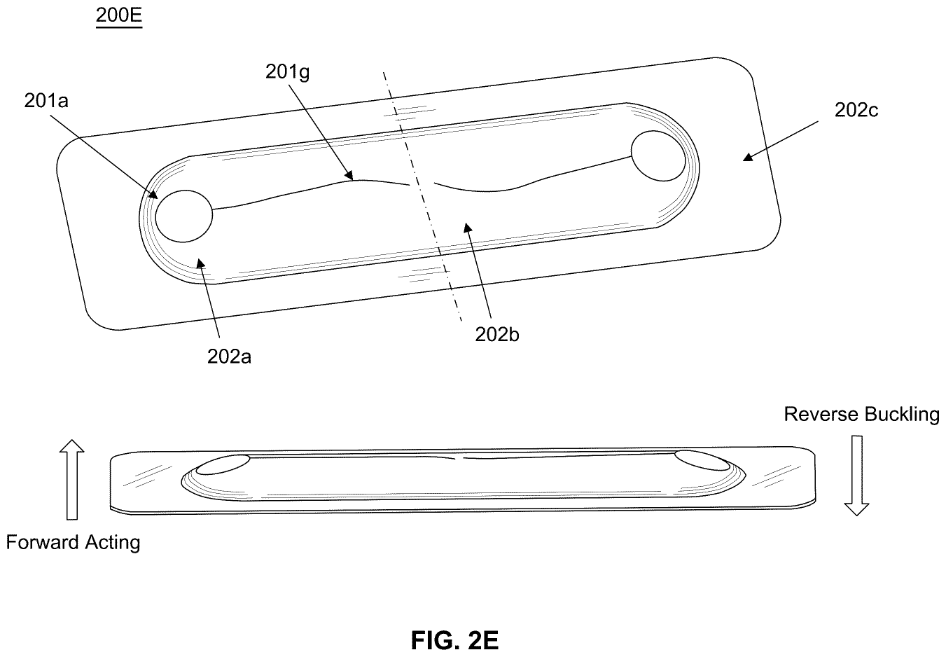

FIGS. 2A-2E illustrate example pressure relief devices, consistent with disclosed embodiments. As shown, a pressure relief device may include a non-circular shape (e.g., an elongated rectangle or obround shape) to improve the airflow upon activation of the device. In some embodiments, the aspect ratio of the pressure relief device is greater than 1:1. In some embodiments, the aspect ratio of the pressure relief device is within the range of 1:1 to 10:1 (e.g., 8:1), inclusive. In some embodiments, the pressure relief device may comprise a curved surface, including a convex and concave side. For example, the non-circular shape may be raised (e.g., in a convex or a concave manner) relative to a base plate or flange.

In some embodiments, the pressure relief device may be metal. For example, the metal may include stainless steel, nickel alloys, aluminum, brass, and/or any other suitable metal. Additionally or alternatively, in some embodiments, the pressure relief device may be a highly flexible graphite. For example, the highly flexible graphite may include graphite that is >99% carbon. Additionally or alternatively, in some embodiments, the pressure relief device may be a polymer. For example, the polymer may include polytetrafluoroethylene (PTFE), fluorinated ethylene propylene (FEP), polyetheretherketone (PEEK), polypropylene (PP), nylon, and/or any other suitable polymer. Additionally or alternatively, in some embodiments, the pressure relief device may be a composite of flexible graphite and polymer. For example, the pressure relief device may include graphite laminated with one or more polymer films, a polymer-infiltrated or polymer-impregnated graphite, or a polymer-coated graphite (e.g., dip-coating, spray-coating, sintering, extrusion lining). Further, the pressure relief device may include hot pressing graphite mixed with polymer powder, polymer extruded onto graphite, or resin-bonded graphite.

In some embodiments, the pressure relief device, including the curved surface, may be created by a forming process. For example, the pressure relief device may be created by blow forming or stamping.

In some embodiments, the pressure relief device, including the curved surface, may be created by a progressive die manufacturing process. As raw material (e.g., metal or graphite) advances through the process, the pressure relief device may be created through a combination of forming, stamping, and scoring. In some embodiments, the process may make the curved surface of the pressure relief device distinct from the flange (e.g., flanged portion 202c) through a combination of forming and stamping steps. In some embodiments, the process may create one or more scored lines of weakness (e.g., 201a-201g) through at least one mechanical scoring step (e.g., a through stamping in a press).

In some embodiments, the pressure relief device may be a forward acting device such that it may open outwards due to pressure on the concave side of the curved surface. For example, in some embodiments, a forward acting pressure relief device may be installed in an application that includes pressure cycling below the activation pressure on the inlet side (e.g., pressure cycling limited to 70% of activation pressure) and/or the outlet side of the device.

In some embodiments, the pressure relief device may be a reverse buckling device such that the curved surface may invert, causing the convex side to collapse into a concave shape and then open. For example, in some embodiments, a reverse buckling pressure relief device may be installed in an application that includes pressure cycling below activation pressure on the inlet and/or the outlet side of the device. Further, the pressure relief device may be reverse buckling when installed in an application that includes a greater variation in operating temperatures as a reverse buckling device may exhibit greater stability over a range of operating temperature conditions. The curved surface may be configured to allow a rapid response when the activation pressure is reached. For example, in a reverse buckling pressure relief device, the curved surface may reverse and fully open within a few milliseconds (e.g., 1 ms, 3 ms, 5 ms, etc.).

As shown in FIGS. 2A-2F, the curved surface of the pressure relief device may include obround ends 202a and a dome 202b. These geometric features may provide benefits in either a forward acting or reverse buckling pressure relief devices. These features may provide structural enhancements that improve the ability of the pressure device to withstand working pressure, vibration, and/or pressure cycling (e.g., from thermal variation) without deformation or fatigue. For example, in applications where there is pressure cycling on the convex side, dome 202b may act in compression and provide high cycle resistance. Additionally, these features may help to resist the device flexing during operating conditions, thereby preventing or mitigating the effects of work-hardening and modifications to the activation pressure.

In some embodiments, the pressure relief device may include one or more lines of weakness designed to ensure opening at a particular location. The one or more lines of weakness may open in response to a particular activation pressure (e.g., may define the burst pressure for a forward-acting device) and/or in a particular “burst pattern.” These lines may be placed (e.g., scored, stamped, formed) on a single plane of the pressure relief device (e.g., the convex or concave side of the curved surface) or both sides of the pressure relief device. A line of weakness may, for example, be a scored line of weakness and may be provided by way of a laser, mechanical displacement, or chemical etching process that involves removing or displacing material from a portion of the pressure relief device. For example, the mechanical displacement may include thinning or cutting the curved surface, using cold-roll indentation, using a slitting wheel, and/or milling (e.g., micro-milling, computer numerical control (CNC) milling, etc.).

In some embodiments, one or more scored lines of weakness may be created by a laser. For example, the one or more scored lines of weakness may be provided by the use of laser ablation and/or laser milling. The one or more scored lines of weakness may be formed anywhere that the beam of light energy can be directed. Because this process is “non-contact,” there is no concern of work-hardening that may occur with mechanical scoring. Traditional manufacturing methods require the construction of specific tooling to make the shape of the line of weakness in the raw material which may be costly and/or time consuming. With laser processing, this process may be replaced by a short period of programming to guide the light beam to the desired location(s). Further, laser processing may be facilitated using preliminary fixtures to hold the material. Such preliminary fixtures may be made, for example, within hours using 3D printing.

In some embodiments, scored lines of weakness may include one or more main structural scores (also referred to herein as a “central line portion”) and one or more end scores (also referred to herein as an “end”). The main structural score may define a plane, and the one or more end scores may be located or extend outside the plane. +For example and as depicted in FIGS. 2A-2C, main structural score 201b may include a single line that is located at or around the apex of the pressure relief device (e.g., within the center third of curved surface). In some embodiments, the main structural score 201b may be located around the apex of the dome 202b in a reverse-buckling pressure relief device. This location may provide multiple benefits. For example, this location may facilitate a consistent burst accuracy once activation pressure is reached because there is limited and/or no distortion at the apex during normal operation. Further, upon activation, this location may facilitate the maximum movement of material to create a high quality opening. Further, upon opening, an apex score may direct pressurized fluid (e.g., hot gas) perpendicularly away from the enclosure (e.g., away from the faulty battery cell(s)), which may aid and/or expedite cooling. Finally, as described below, an apex score may reduce the impact that a welding installation process may have on the main structural score 201b.

While shown as a single line, in some embodiments, main structural score 201b may include multiple and/or intermittent lines (e.g., forming a stitch). A stitched score line of weakness may be used to configure a set activation pressure and/or provide desired ventilation. In some embodiments, the path(s) of the main structural score(s) may also be tailored to accommodate a particular application. The path of the score may refer to a shape, length, and/or pattern of a score. For instance, the path of the main structural score may be adjusted to maximize the opening characteristics based on activation pressure, aspect ratio, and/or other design considerations. Further, the path of the main structural score may be adjusted to influence the flow direction of pressurized fluid.

In some embodiments, an end score may include a line of weakness with a curved shape (e.g., a circle) that is applied to each end of the score. An end score may define the opening characteristics on one or more ends of the pressure relief device. As shown in examples below, the end scores can be in the form of a full circle, a hook shape, or a fork shape. Different shapes can be applied, as desired, based on, e.g., device size, aspect ratio and activation pressure. The end scores may maximize the opening at each end of the pressure relief device. The ends of the pressure relief device may be strong (e.g., resist opening), especially when there is a higher aspect ratio. Therefore, the end scores may be configured to maximize the opening characteristics in these areas and provide maximum flow.

In some embodiments, the end scores may be circles. For example, as depicted in FIG. 2A, pressure relief device 200A may include end scores 201a that are shaped like a circle and connected to main structural score 201b.

In some embodiments, the end scores may be semicircles. For example, as depicted in FIG. 2B, pressure relief device 200B may include end scores 201c that are shaped like semicircles and connected to main structural score 201b at an end of the arc of the semicircle (e.g., hook-shaped). By way of another example, as depicted in FIG. 2C, pressure relief device 200C may include end scores 201d that are shaped like semicircles and connected to main structural score 201b at a center of the arc of the semicircle (e.g., fork-shaped).

While FIGS. 2A-2C show some non-limiting examples of different end scores, the end scores may be configured in any manner required to effectively open the pressure relief device and/or direct pressurized fluid away from the enclosure. For example, a semicircle end score may be connected to main structural score 201b at one or more other points along the arc of the semicircle. Further, the end scores may not be connected to main structural score 201b. Additionally, other shapes for the end scores, such as an arc between 0 degrees and 360 degrees, exclusive; bending lines; zigzag lines; any polygon (e.g., triangle); or any other shape are also contemplated within the scope of this disclosure.

In some embodiments, the main structural score may include one or more bending lines along an apex of the dome. For example, as shown in FIG. 2D, pressure relief device 200D may include main structural score 201f that includes one or more bending lines along the apex of the dome 202b. A bending line may include a line with at least one bend or curve. For example, main structural score 201f may include first and second lines extending from opposite ends of the device. In some embodiments, the first line may be symmetric to the second line about a longitudinal axis (as shown by the dashed line). In other embodiments, the first line may be a reflection (i.e., mirror image) of the second line along a latitudinal axis (perpendicular to the dashed line, not shown). In still other embodiments, the first line and the second line may be asymmetric about the longitudinal axis. In some embodiments, the one or more bending lines may be connected. For example, main structural score 201f may be a single connected line with symmetric bends about the longitudinal axis of the pressure relief device. In other embodiments, the one or more bending lines may be discontinuous. For example, main structural score 201f may be two or more separate lines that are not each connected to each other.

In some embodiments, the main structural score may include first and second lines extending from opposite ends of the device. For example, as shown in FIG. 2E, pressure relief device 200E may include main structural score 201g that includes first and second lines extending from opposite ends of pressure relief device 200E. In some embodiments, the first line may be a point reflection of the second line about a longitudinal axis (shown by the dashed line) and a latitudinal axis (not shown) of pressure relief device 200E.

While FIGS. 2A-2E show some non-limiting examples of different main structural scores, the main structural scores may be configured in any manner required to effectively open the pressure relief device and/or direct pressurized fluid away from the enclosure. In some embodiments, the pressure relief device of any one of FIGS. 2A-2E may have an activation pressure in the range of approximately 100 kilopascals (kPa) to 34500 kPa or 14.5 pounds per square inch gauge (PSIG) to 5000 PSIG, inclusive.

In some embodiments, the pressure relief device may include a flanged portion 202c. For example, the process used to create the curved surface (e.g., including obround ends 202a and dome 202b) may also create a perimeter flanged portion 202c with a high degree of flatness (e.g., +/−2% and/or not exceeding the thickness of flange material). The flanged portion 202c may provide a means for securing the pressure relief device (e.g., to enclosure 102) through an automated assembly process, such as a welding process. Also, the pressure relief device, including the flanged portion 202c, may be configured to minimize any effect of the welding process on the curved surface (including 202a and 202b) and scores (201a and 201b). For example, scores 201a and 201b may be spaced away from the flanged portion 202c to avoid being affected by the welding process. In some embodiments, scores 201a and 201b may be spaced at least 1 mm away, while in other embodiments scores 201a and 201b may be spaced at least 3 mm away.

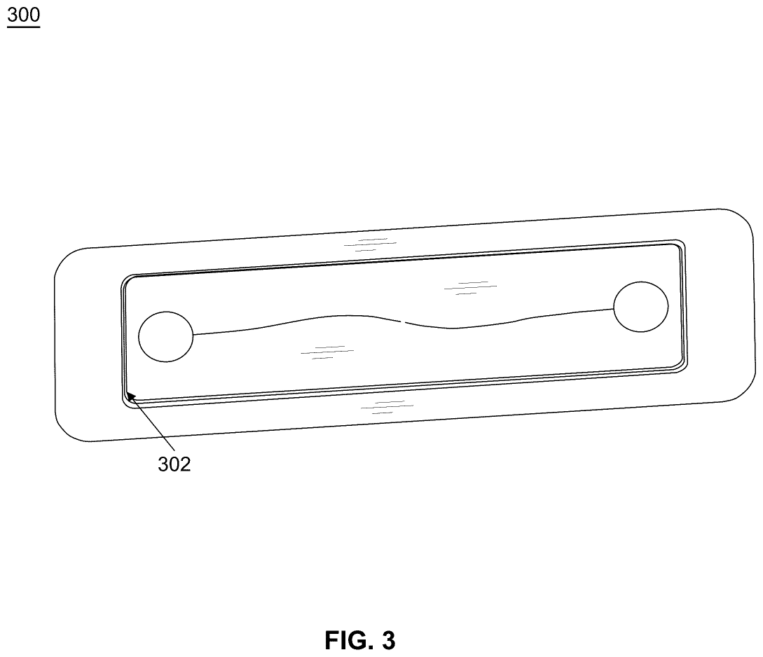

FIG. 3 illustrates another example pressure relief device 300, consistent with disclosed embodiments. As illustrated, pressure relief device 300 may include a curved surface with rectangular ends 302. In some embodiments, pressure relief device 300 may include a dome 202b with a cross section similar to that shown in FIGS. 2A-2E. In some embodiments, pressure relief device 300 may include any combination of end scores and main structural scores described above with respect to FIGS. 2A-2E. In some embodiments, pressure relief device 300 may have an activation pressure of less than 100 kPa (i.e., 1 bar), such as an activation pressure in a range of 103 kPa to 201 kPa or 0.2 PSIG to 14.5 PSIG.

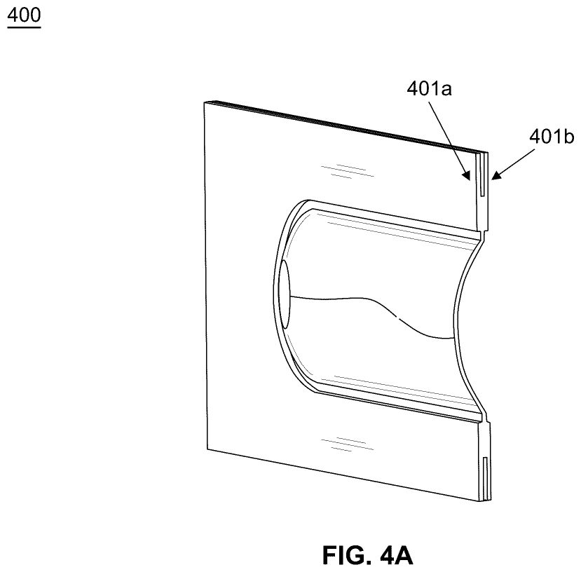

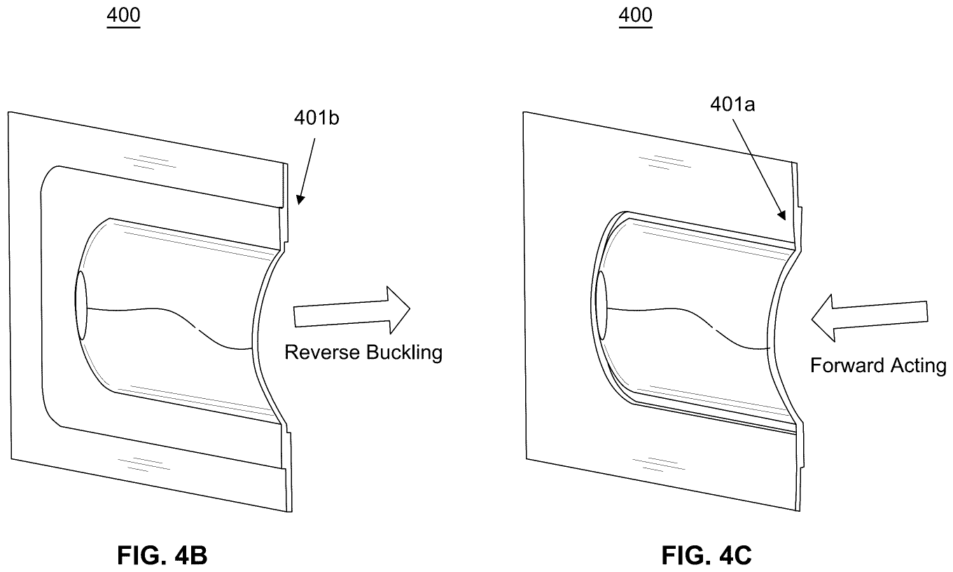

FIGS. 4A-4C illustrate example mounting of pressure relief device 400, consistent with disclosed embodiments. In some embodiments, at least one side of pressure relief device 400 may be fixed a support plate by welding, soldering, or other mechanical fixing. In some embodiments, support plates may be constructed of metal, such as stainless steel, aluminum, and/or other metallic material. As shown in FIG. 4A, in some embodiments, pressure relief device 400 may be sandwiched between two support plates 401a and 401b. As shown in FIG. 4B, in some embodiments, pressure relief device 400 may be a reverse-buckling device and support plate 401b may be fixed on the outlet side of pressure relief device 400. As shown in FIG. 4C, in some embodiments, pressure relief device 400 may be a forward acting device and support plate 401a may be fixed on the outlet side of the pressure relief device.

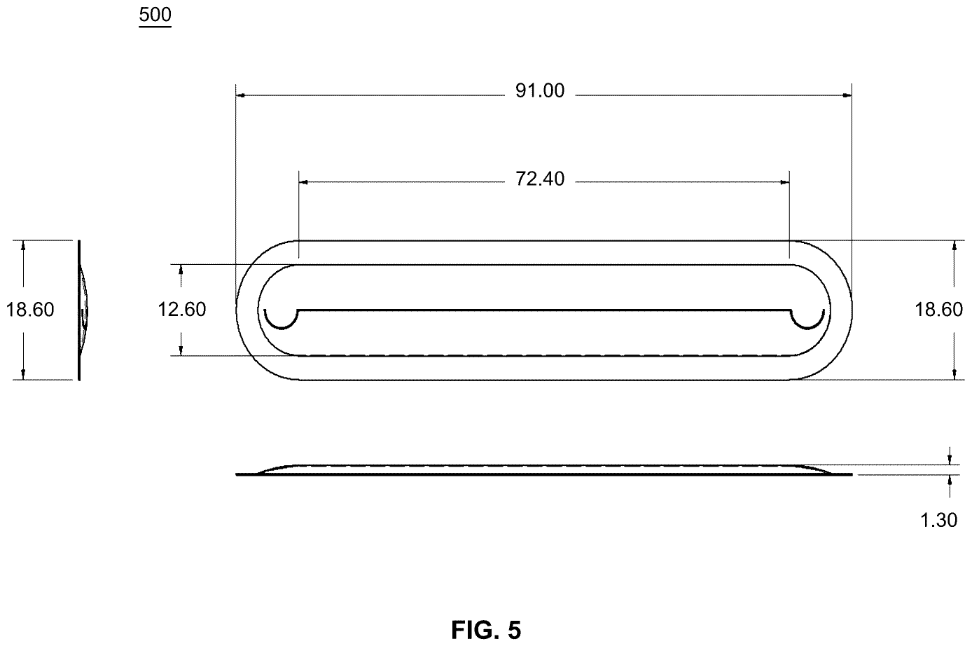

FIG. 5 illustrates example dimensions of pressure relief device 500, consistent with disclosed embodiments. In some embodiments, pressure relief device 500 may be a reverse-buckling device with a dome section (e.g., dome 202b) that is between 30 mm and 100 mm long (e.g., 72.40 mm long), 5 mm and 20 mm wide (e.g., 12.60 mm wide), and 0.5 mm and 3 mm deep (e.g., 1.30 mm deep). In some embodiments, pressure relief device 500 may include at least one end section (e.g., obround end 202a) that is between 3 mm and 20 mm wide (e.g., 9.3 mm wide) and 5 mm and 20 mm long (e.g., 12.60 mm wide). In some embodiments, pressure relief device 500 may include a flanged section (e.g., flanged portion 202c) that is between 1 mm and 6 mm wide (e.g., 3 mm wide).

While some of the described example pressure relief devices are shown as rectangular or obround shapes, in other embodiments the pressure relief devices may be other shapes. For example, the pressure relief devices may be configured such that a plan view of the curved surface forms a crescent, trapezoid, parallelogram, semicircle, rhombus, pentagon, hexagon, octagon, and/or any other configuration required to meet installation constraints and/or airflow requirements. These shapes may be regular or irregular (e.g., slanted, skewed, asymmetric) as required to meet the application requirements.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, any number of the aforementioned embodiments may be suitably combined.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. These terms are used to distinguish one element from another. For example, a first element could be termed a second element, and, similarly, a second element could be termed a first element, without departing from the scope of the embodiments.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a system may include A or B, then, unless specifically stated otherwise or infeasible, the system may include A, or B, or A and B. As a second example, if it is stated that a system may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A pressure relief device, comprising:
a flanged portion;
a curved surface; and
one or more lines of weakness on the curved surface, the one or more lines of weakness comprising a first end, a central line portion, and a second end,
wherein at least one of the first end or the second end extends outside of a plane defined by the central line portion, and
wherein the curved surface has an aspect ratio greater than 1:1.

2. The pressure relief device of claim 1, wherein the one or more lines of weakness are created on the curved surface by a laser.

3. The pressure relief device of claim 1, wherein at least one of the first end or the second end is a circle.

4. The pressure relief device of claim 1, wherein at least one of the first end or the second end is a semicircle.

5. The pressure relief device of claim 4, wherein the central line portion is connected to an end of an arc of the semicircle.

6. The pressure relief device of claim 4, wherein the central line portion is connected to a center of an arc of the semicircle.

7. The pressure relief device of claim 1, wherein the central line portion is located at an apex of the curved surface.

8. The pressure relief device of claim 1, wherein the central line portion includes one or more bending lines located along an apex of the curved surface.

9. The pressure relief device of claim 1, wherein the central line portion includes at least two discontinuous lines located along an apex of the curved surface.

10. The pressure relief device of claim 1, wherein the curved surface is rectangular when viewed in a plan view.

11. The pressure relief device of claim 1, wherein the curved surface is obround when viewed in a plan view.

12. The pressure relief device of claim 1, wherein the flanged portion is created through a forming and stamping process that makes the flanged portion distinct from the curved surface.

13. The pressure relief device of claim 1, wherein the one or more lines of weakness are spaced at least 1 mm away from the flanged portion.

14. The pressure relief device of claim 1, wherein the curved surface is at least one of:
metal, graphite, or a polymer.

15. The pressure relief device of claim 1, wherein a support plate is fixed to at least one side of the flanged portion.

16. A pressure relief device, comprising:
a flanged portion;
a curved surface;
a first line of weakness located along an apex of the curved surface, comprising a first end and a first central line portion; and
a second line of weakness located along the apex of the curved surface, comprising a second end and a second central line portion,
wherein the first line of weakness and the second line of weakness are symmetric about a longitudinal axis of the curved surface
wherein the first line of weakness and the second line of weakness are not connected, and
wherein the curved surface has an aspect ratio greater than 1:1.

17. The pressure relief device of claim 16, wherein the first end and the second end are circles.

18. The pressure relief device of claim 16, wherein the first end and the second end are semicircles.

19. A pressure relief device, comprising:
a flanged portion;
a curved surface; and
stitched score lines of weakness on the curved surface, the stitched score lines of weakness comprising a first end, a central line portion, and a second end,
wherein at least one of the first end or the second end extends outside of a plane defined by the central line portion, and
wherein the curved surface has an aspect ratio greater than 1:1.

20. The pressure relief device of claim 19, wherein the first end and the second end are circles or semicircles.
